(19) United States
(12) Patent Application Publication
(10) Pub. No.: US 2009/0288778 A1
(43) Pub. Date: Nov. 26, 2009

(54) LABELING MACHINE WITH A LABEL PRESSING DEVICE

(75) Inventor: Sheng-Hui Yang, Taichung City (TW)

Correspondence Address: TUROCY & WATSON, LLP, 127 Public Square, 57th Floor, Key Tower, CLEVELAND, OH, 44114, US

(73) Assignee: CVC TECHNOLOGIES, INC., Taichung Hsien (TW)

(21) Appl. No.: 12/197,548

(22) Filed: Aug. 25, 2008

(30) Foreign Application Priority Data
May 22, 2008 (TW) 097208903

(51) Int. Cl. B32B 37/10

(52) U.S. Cl. 156/538

(57) ABSTRACT

A labeling machine includes a conveying device, a label applying device, and a label pressing device. The conveying device includes opposite upper and lower conveyer belts adapted for conveying a container such that upper and lower ends of the container are contacted by the upper and lower conveyer belts, respectively. The label applying device is adapted to attach a portion of the label on an initial label attaching portion of the container on the conveying device. The label pressing device includes a first press unit adapted to press a first segment of the label against the container while the container is being conveyed by the conveying device in a conveying direction, and a second press unit adapted to press a second segment of the label against the container while the container is being conveyed by the conveying device in the conveying direction.

### BACKGROUND OF THE INVENTION

1. Field of the Invention

The invention relates to a labeling machine, more particularly to a labeling machine with a label pressing device.

2. Description of the Related Art

As shown in FIG. 1, a conventional labeling machine 1 includes a conveyer belt 11 adapted for conveying a container 21, and a label applying device 12 including a reel 121, a plurality of guide rollers 122, and a label applicator plate 123. A label unit 22 comprising a plurality of labels 221 is wound on the reel 121, and has one end drawn to the label applicator plate 123 through guidance of the guide rollers 122, such that each of the labels 221 is separated from the label unit 22 by the label applicator plate 123. When the container 21 is conveyed to a position near the label applicator plate 123, an end portion of a separated label 221 is adhered on a portion of the container 21, and the container 21 rotates due to contact between the label 221 and the container 21 while the container 21 is being conveyed by the conveyer belt 11, thereby attaching completely the label 221 on the container 21.

However, since the container 21 rotates during the label attaching process, it is difficult to attach a user's manual 23 (see FIG. 2) to the container 21 in an automated manner without covering at least a part of the label 221 on the container 21. Therefore, the manual 23 has to be manually attached to the container 21 after the label attaching process, thereby incurring higher costs.

### SUMMARY OF THE INVENTION

Therefore, the object of the present invention is to provide a labeling machine that can prevent a container conveyed thereon from rotating, and that has a label pressing device for pressing a label against the container.

Accordingly, a labeling machine of the present invention comprises a conveying device, a label applying device, and a label pressing device. The conveying device includes opposite upper and lower conveyer belts that define a container positioning space therebetween adapted for receiving a container such that upper and lower ends of the container are contacted by the upper and lower conveyer belts, respectively, and that are adapted for conveying the container in a conveying direction. The label applying device is adapted for attaching a label on the container on the conveying device. The label has opposite first and second lateral label ends and a middle label portion between the first and second lateral label ends. The label applying device is adapted to attach the middle label portion on an initial label attaching portion of the container on the conveying device. The label pressing device includes a first press unit disposed downstream of the label applying device and adapted to press a first segment of the label between the middle label portion and the first lateral label end against the container while the container is being conveyed by the conveying device in the conveying direction, and a second press unit disposed downstream of the first press unit and adapted to press a second segment of the label between the middle label portion and the second lateral label end against the container while the container is being conveyed by the conveying device in the conveying direction.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic top view of a conventional labeling machine;

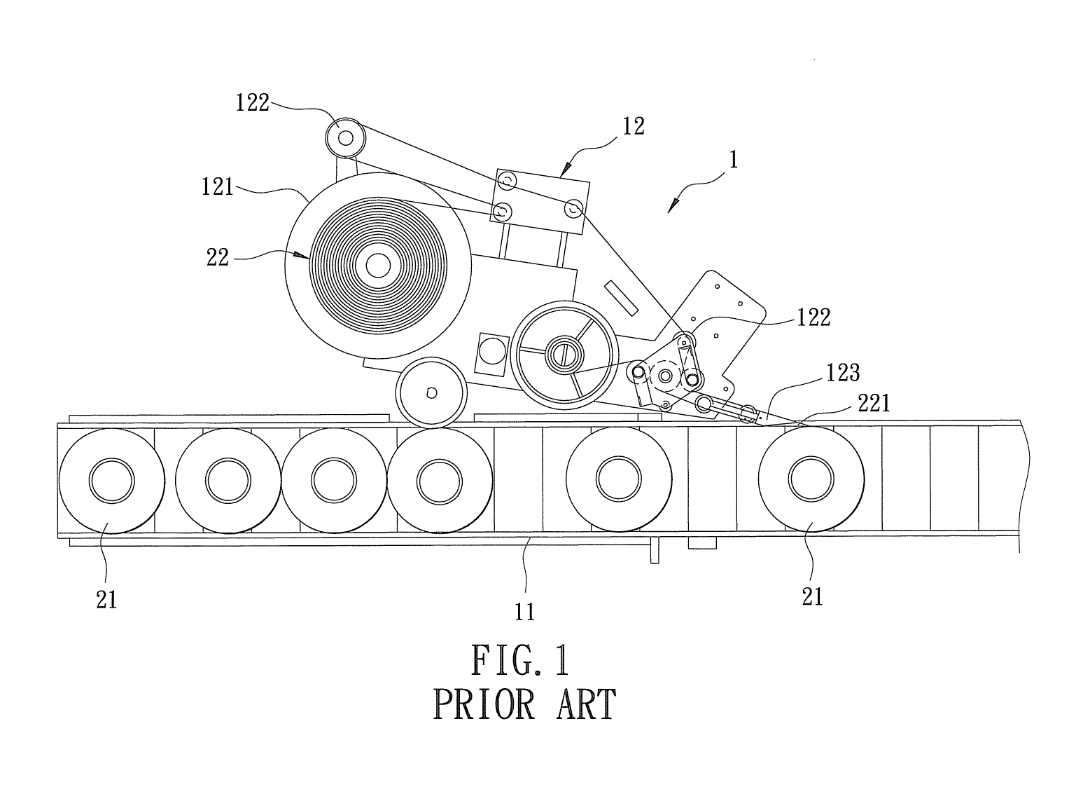

FIG. 2 is a perspective view of a container attached with a label and a manual;

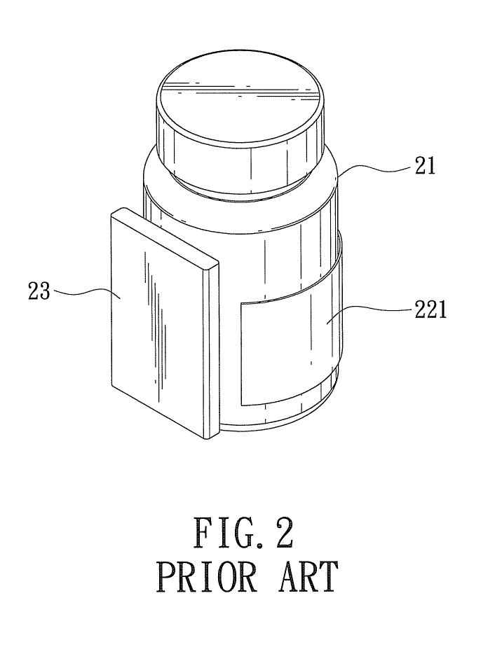

FIG. 3 is a schematic top view of a preferred embodiment of a labeling machine according to the present invention;

FIG. 4 is a perspective view of a label pressing device of the preferred embodiment;

FIG. 5 is a top view of a container attached with a label and a manual using the preferred embodiment;

FIG. 6 is a schematic top view of the preferred embodiment, illustrating operation of a first press unit;

FIG. 7a is a schematic top view of the preferred embodiment, illustrating the label before being pressed against the container by a second press unit;

FIG. 7b is another schematic top view of the preferred embodiment, illustrating the label being pressed against the container by the second press unit; and

FIG. 7c is still another schematic top view of the preferred embodiment, illustrating the label after being pressed against the container by the second press unit.

### DETAILED DESCRIPTION OF THE PREFERRED EMBODIMENT

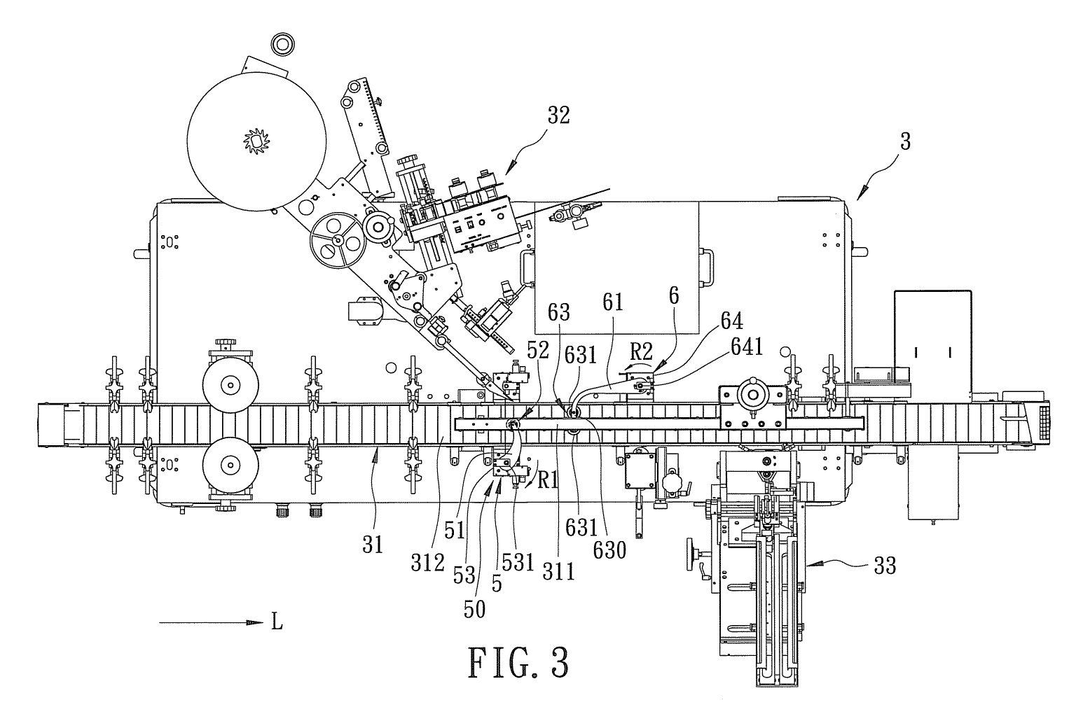

As shown in FIGS. 3, 4, and 5, the preferred embodiment of a labeling machine 3 according to the present invention comprises a conveying device 31, a label applying device 32, a label pressing device 50 including first and second press units 5, 6, and a manual attaching device 33.

The conveying device 31 includes opposite upper and lower conveyer belts 311, 312, that define a container positioning space 310 therebetween adapted for receiving a container 41 such that upper and lower ends of the container 41 are contacted by the upper and lower conveyer belts 311, 312, respectively, and that are adapted for conveying the container 41 in a conveying direction (L).

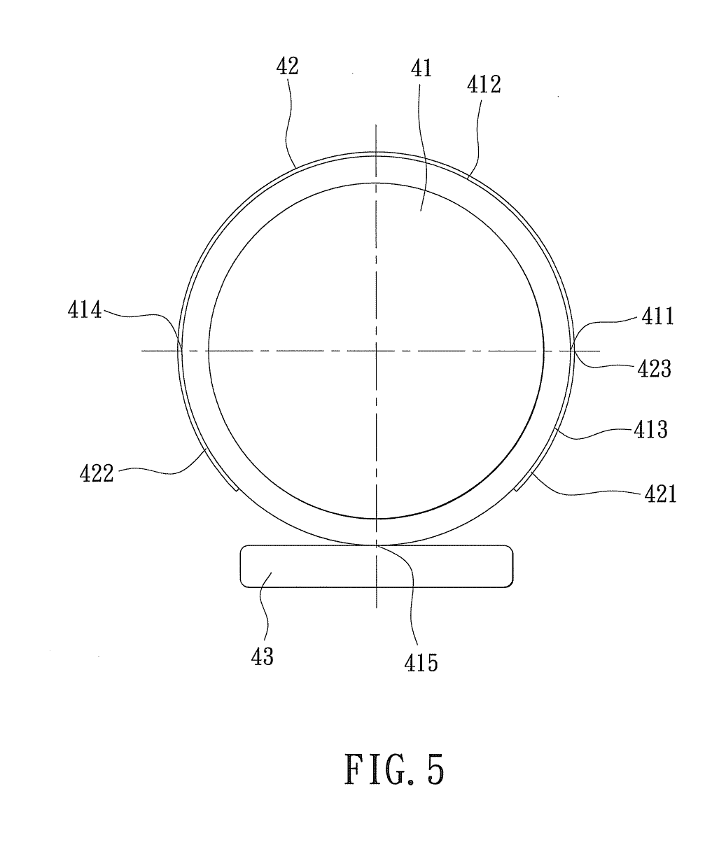

As best shown in FIG. 5, the container 41 has an initial label attaching portion 411, a first container side 412 at one side of the initial label attaching portion 411, a second container side 413 at the other side of the initial label attaching portion 411 opposite to the first container side 412, and an opposite container side 414 opposite to the initial label attaching portion 411.

The label applying device 32 is adapted for attaching a label 42 on the container 41 on the conveying device 31. The label 42 has opposite first and second lateral label ends 421, 422 and a middle label portion 423 between the first and second lateral label ends 421, 422.

The first press unit 5 of the label pressing device 50 is disposed downstream of the label applying device 32 in the conveying direction (L) and is adapted to press a first segment of the label 42 between the middle label portion 423 and the first lateral label end 421 against the container 41 while the container 41 is being conveyed by the conveying device 31 in the conveying direction (L). The first press unit 5 includes a first swingable arm 51, a first pressing roller unit 52, and a first driver 53. The first swingable arm 51 extends swingably from one of two opposite lateral sides of the conveying device 31 into the container positioning space 310. The first pressing roller unit 52 includes a first pressing roller 521 connected rotatably to the first swingable arm 51. The first swingable arm 51 is biased such that the first pressing roller 521 is normally disposed in the container positioning space 310 of the conveying device 31. In this embodiment, the first driver 53 is a rotary pressure cylinder, and has a first driving axle 531 for driving the first swingable arm 51 to swing in a first angular direction (R1), which is a clockwise direction in this embodiment.

The second press unit 6 is disposed downstream of the first press unit 5 in the conveying direction (L) and is adapted to press a second segment of the label 42 between the middle label portion 423 and the second lateral label end 422 against the container 41 while the container 41 is being conveyed by the conveying device 31 in the conveying direction (L).

In this embodiment, the second press unit 6 includes a second swingable arm 61, a second pressing roller unit 63, and a second driver 64. The second swingable arm 61 extends swingably from the other of the two opposite lateral sides of the conveying device 31 into the container positioning space 310. The second pressing roller unit 63 includes a pivot arm 630 pivotally connected to the second swingable arm 61, and a pair of parallel second pressing rollers 631 carried rotatably by the pivot arm 630. The second swingable arm 61 is biased such that one of the second pressing rollers 631 is normally disposed in the container positioning space 310 of the conveying device 31. In this embodiment, the second driver 64 is also a rotary pressure cylinder, and has a second driving axle 641 for driving the second swingable arm 61 to swing in a second angular direction (R2) opposite to the first angular direction (R1), i.e., the second angular direction (R2) is a counterclockwise direction in this embodiment.

In this embodiment, the first driver 53 of the first press unit 5 and the second driver 64 of the second press unit 6 are disposed respectively at the opposite lateral sides of the conveying device 31, and the first swingable arm 51 of the first press unit 5 and the second swingable arm 61 of the second press unit 6 extend respectively from the first and second drivers 53, 64 into the container positioning space 310 of the conveying device 31. The manual attaching device 33 is disposed at the same lateral side of the conveying device 31 as the first press unit 5, is disposed downstream of the second press unit 6 in the conveying direction (L), and is adapted for attaching a user's manual 43 (see FIG. 5) to the container 41.

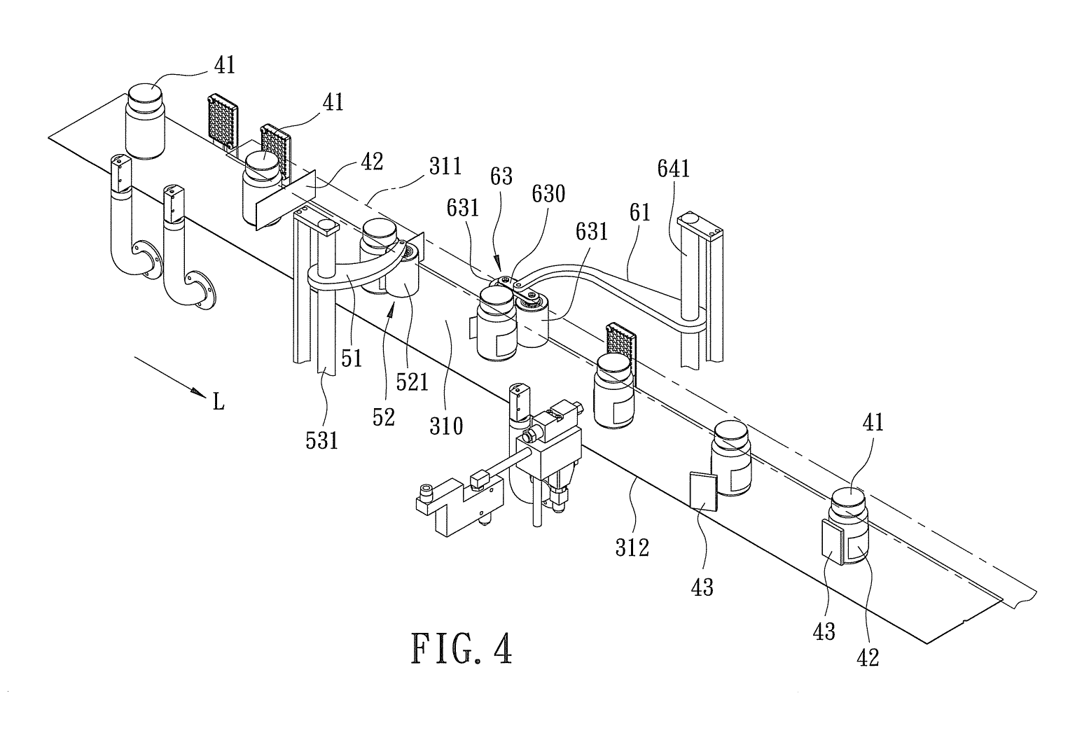

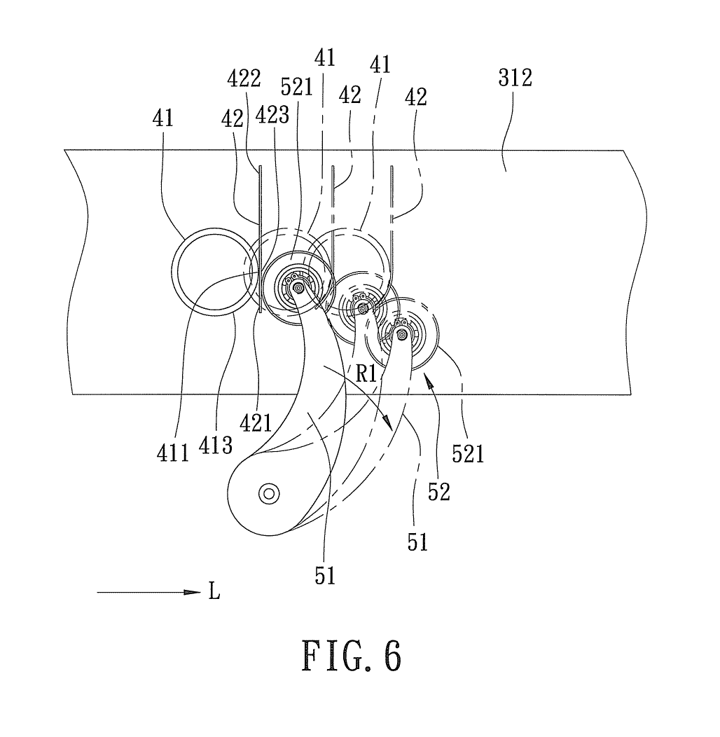

Referring to FIGS. 4 to 6, during the operation of the labeling machine 3, when the container 41 is retained between the upper and lower conveyer belts 311, 312 of the conveying device 31 and is conveyed in the conveying direction (L) to a position adjacent to the label applying device 32, the middle label portion 423 of the label 42 is attached by the label applying device 32 on the initial label attaching portion 411 of the container 41. When the container 41 is advanced to a position where the first pressing roller 521 of the first pressing roller unit 52 of the first press unit 5 contacts the container 41, the first driver 53 of the first press unit 5 is activated to drive the first swingable arm 51 to swing in the first angular direction (R1) while the first pressing roller 521 is moved rotatably from the initial label attaching portion 411 toward the second container side 413 of the container 41, thereby pressing firmly the first segment of the label 42 from the middle label portion 423 to the first lateral label end 421 against the container 41.

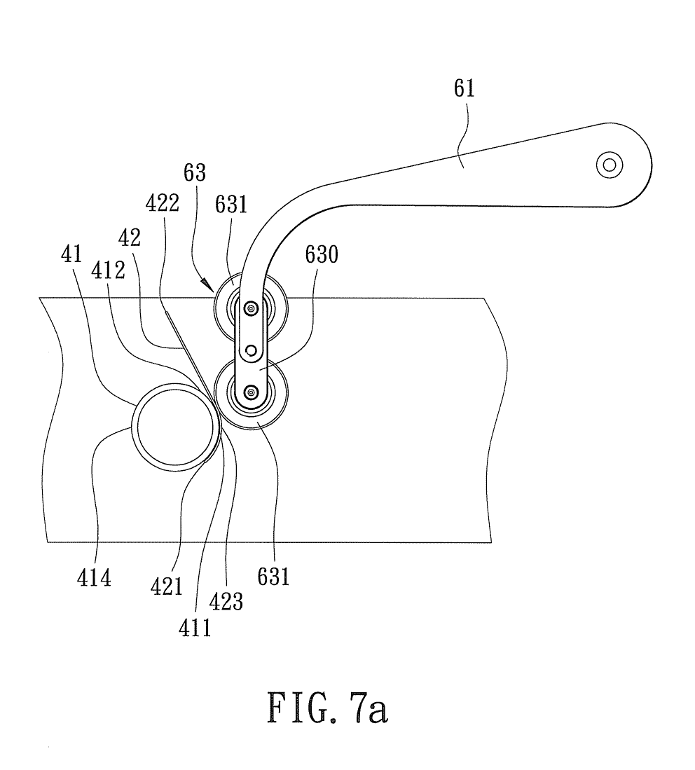

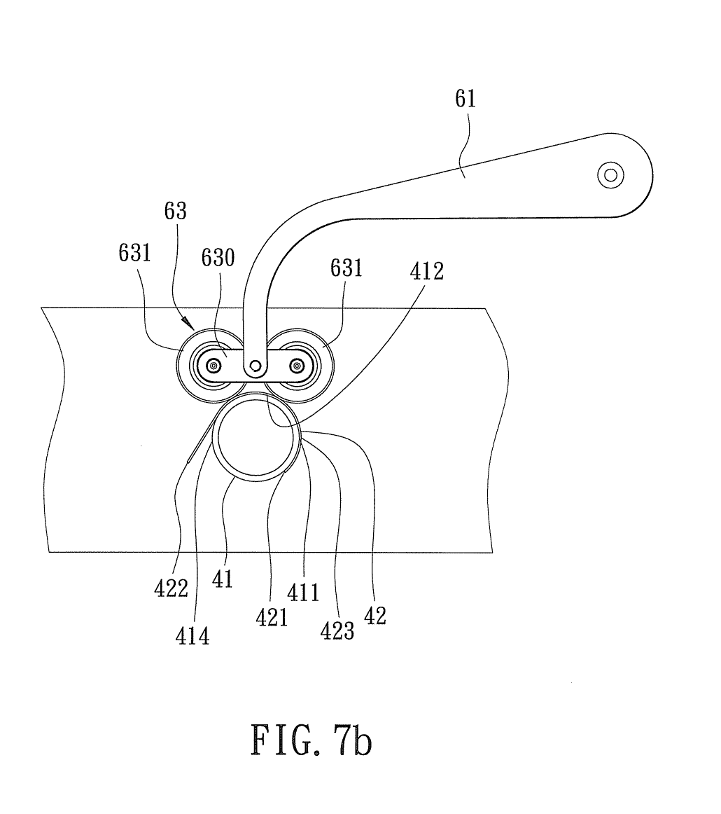

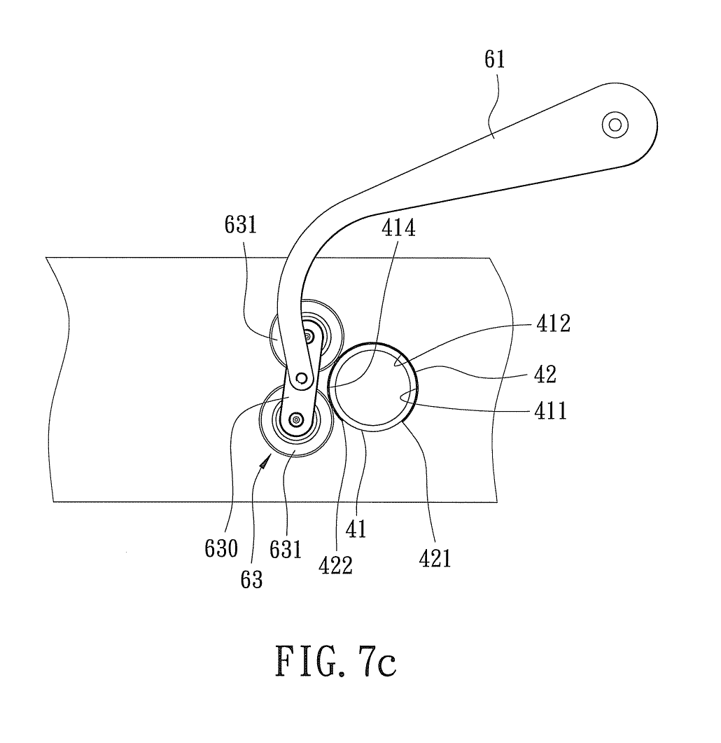

Afterward, as shown in FIGS. 4, 5, and 7a to 7c, when the container 41 is further advanced in the conveying direction (L) to a position where one of the second pressing rollers 631 of the second pressing roller unit 63 of the second press unit 6 contacts the container 41, the second driver 64 of the second press unit 6 is activated to drive the second swingable arm 61 to swing in the second angular direction (R2), thereby causing both of the second pressing rollers 631 to contact the container 41 via pivoting movement of the pivot arm 630 on the second swingable arm 61 and thereby moving the second pressing rollers 631 rotatably from the initial label attaching portion 411, along the first container side 412, and toward the opposite container side 414, such that the second segment of the label 42 from the middle label portion 423 to the second lateral label end 422 is pressed firmly against the container 41. Therefore, the whole label 42 is attached firmly on the container 41, while a manual attaching portion 415 (see FIG. 5) is formed on the container 41 and is not covered by the label 42.

Since the upper and lower ends of the container 41 are contacted respectively by the upper and lower conveyer belts 311, 312 of the conveying device 31, the container 41 is positioned stably during the conveying process and is prevented from rotating. Therefore, the manual attaching portion 415 of the container 41 remains at the same angular orientation relative to the conveying device 31 during the container conveying process, thereby facilitating automated attachment of the user's manual 43 on the manual attaching portion 415 of the container 41 through the manual attaching device 33 to result in lower costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A labeling machine comprising:
a conveying device including opposite upper and lower conveyer belts that define a container positioning space therebetween adapted for receiving a container such that upper and lower ends of the container are contacted by said upper and lower conveyer belts, respectively, and that are adapted for conveying the container in a conveying direction;
a label applying device adapted for attaching a label on the container on said conveying device, the label having opposite first and second lateral label ends and a middle label portion between the first and second lateral label ends, said label applying device being adapted to attach the middle label portion on an initial label attaching portion of the container on said conveying device; and
a label pressing device including
a first press unit disposed downstream of said label applying device and adapted to press a first segment of the label between the middle label portion and the first lateral label end against the container while the container is being conveyed by said conveying device in the conveying direction, and
a second press unit disposed downstream of said first press unit and adapted to press a second segment of the label between the middle label portion and the second lateral label end against the container while the container is being conveyed by said conveying device in the conveying direction.

2. The labeling machine as claimed in claim 1, wherein said first press unit includes:
a first swingable arm extending swingably from one of two opposite lateral sides of said conveying device into said container positioning space;
a first pressing roller unit disposed in said container positioning space of said conveying device, and connected rotatably to said first swingable arm; and
a first driver for driving said first swingable arm to swing in a first angular direction while said first pressing roller unit presses firmly the first segment of the label from the middle label portion to the first lateral label end against the container being conveyed by said conveying device.

3. The labeling machine as claimed in claim 2, wherein said second press unit includes:
a second swingable arm extending swingably from the other of said two opposite lateral sides of said conveying device into said container positioning space;
a second pressing roller unit disposed in said container positioning space of said conveying device, and connected rotatably to said second swingable arm; and
a second driver for driving said second swingable arm to swing in a second angular direction opposite to the first angular direction while said second pressing roller unit presses firmly the second segment of the label from the middle label portion to the second lateral label end against the container being conveyed by said conveying device.

4. The labeling machine as claimed in claim 3, wherein:
said first and second drivers are disposed respectively at said opposite lateral sides of said conveying device; and
said first and second swingable arms extend respectively from said first and second drivers into said container positioning space of said conveying device.

5. The labeling machine as claimed in claim 4, wherein each of said first and second drivers is a rotary pressure cylinder.

6. The labeling machine as claimed in claim 3, wherein one of said first and second pressing roller units includes a pivot arm pivotally connected to a respective one of said first and second swingable arms and a pair of pressing rollers carried rotatably by said pivot arm.

7. The labeling machine as claimed in claim 1, wherein one of said first and second press units includes:
a swingable arm extending swingably into said container positioning space;
a pressing roller unit disposed in said container positioning space of said conveying device, and connected rotatably to said swingable arm; and
a driver for driving said swingable arm to swing while said pressing roller unit presses firmly one of the first and second segments of the label against the container being conveyed by said conveying device.

8. A label pressing device adapted for use with a labeling machine, the labeling machine including
a conveying device including opposite upper and lower conveyer belts that define a container positioning space therebetween for receiving a container such that upper and lower ends of the container are contacted by the upper and lower conveyer belts, respectively, and that convey the container in a conveying direction, and
a label applying device for attaching a label on the container on the conveying device, the label having opposite first and second lateral label ends and a middle label portion between the first and second lateral label ends, the label applying device attaching the middle label portion on an initial label attaching portion of the container on the conveying device,
said label pressing device comprising:
a first press unit adapted to press a first segment of the label between the middle label portion and the first lateral label end against the container while the container is being conveyed by the conveying device in the conveying direction;
wherein said first press unit includes: a first swingable arm adapted to be disposed so as to extend swingably from one of two opposite lateral sides of the conveying device into the container positioning space; a first pressing roller unit adapted to be disposed in the container positioning space of the conveying device, and connected rotatably to said first swingable arm; and a first driver for driving said first swingable arm to swing in a first angular direction while said first pressing roller unit presses firmly the first segment of the label from the middle label portion to the first lateral label end against the container being conveyed by the conveying device; and
a second press unit adapted to press a second segment of the label between the middle label portion and the second lateral label end against the container while the container is being conveyed by the conveying device in the conveying direction;
wherein said second press unit includes: a second swingable arm adapted to be disposed so as to extend swingably from the other of said two opposite lateral sides of said conveying device into said container positioning space; a second pressing roller unit adapted to be disposed in the container positioning space of the conveying device, and connected rotatably to said second swingable arm; and a second driver for driving said second swingable arm to swing in a second angular direction opposite to the first angular direction while said second pressing roller unit presses firmly the second segment of the label from the middle label portion to the second lateral label end against the container being conveyed by the conveying device.

9. The label pressing device as claimed in claim 8, wherein:
said first press unit is adapted to be disposed downstream of the label applying device of the labeling machine; and
said second press unit is adapted to be disposed downstream of said first press unit.

10. The label pressing device as claimed in claim 8, wherein:
said first and second drivers are adapted to be disposed respectively at the opposite lateral sides of the conveying device; and
said first and second swingable arms extend respectively from said first and second drivers into the container positioning space of the conveying device.

11. The label pressing device as claimed in claim 8, wherein each of said first and second drivers is a rotary pressure cylinder.

12. The label pressing device as claimed in claim 8, wherein one of said first and second pressing roller units includes a pivot arm pivotally connected to a respective one of said first and second swingable arms, and a pair of pressing rollers carried rotatably by said pivot arm.
